(19) United States
(12) Patent Application Publication
(10) Pub. No.: US 2005/0059279 A1
(43) Pub. Date: Mar. 17, 2005

(54) Electrical connector with improved grounding structure

(76) Inventors: Jing Ping Zu, Kunsan (CN); Chun Sheng Li, Kunsan (CN); Xiao Liang Chen, Kunsan (CN); Feng Zhu, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/940,245

(22) Filed: Sep. 13, 2004

(30) Foreign Application Priority Data
Sep. 11, 2003 (CN) 03278511.9

(51) Int. Cl. H01R 4/66

(52) U.S. Cl. 439/92

(57) ABSTRACT

An electronic connector (1) includes a dielectric housing (10), a number of terminals (20) received in the dielectric housing, a shell (30) mounted on the dielectric housing, a spacer (50) and a pair of ground plates (40). The dielectric housing includes a base (11), a pair of brackets (13) extending downwardly from opposite ends of the base. Each bracket has a shoulder (132) defining a retention slit (1322) extending therethrough. The ground plates are received in the retention slits. The shell has a pair of cantilever arms (33) received in the retention slits and electrically connecting with the ground plates.

### BACKGROUND OF THE INVENTION

1. Field of the Invention

The present invention generally relates to an electrical connector, and more particularly to an electrical connector having an improved grounding structure.

2. Description of Prior Art

With the rapid development of electronic industry, an electrical connector is widely used for transmitting signal between electronic equipments. However, the electronic signals are easily subject to external Electro Magnetic Interference (EMI) during transmitting. In order to reduce or avoid the EMI, the electrical connector usually has a shielding shell, which shall be grounded to a grounding path of a printed circuit board (PCB) to dissipate electrostatic charges accumulated on the shell. One conventional method of grounding the shielding shell is to dispose a grounding leg integrally formed with the shielding shell and connected with the grounding trace of the PCB. But the shielding shell having the grounding leg is relative complex in structure, particularly used in a high profile electrical connector. Another method of grounding the shielding shell is to provide a separated grounding device and a shielding shell, which are connected together via a bolt or rivet. U.S. Pat. No. 6,305,953 discloses such an electrical connector having a shielding shell, a pair of grounding plates, a pair of board locks and a pair of rivets. The board locks and grounding plates are fixed to opposite ends of the housing by the rivets. A resilient finger of each grounding plate contacts the shielding shell, thus the shielding shell is electrically grounded to the grounding traces via grounding plates and board locks. However, such kind of electrical connector includes many auxiliary components, which complicates the manufacturing and assembling process, thereby decreasing the production efficiency and increasing the cost of the electrical connector.

Hence, an electrical connector having simple grounding structure is required to overcome the disadvantages of the prior art.

### SUMMARY OF THE INVENTION

An object of the present invention is to provide an electrical connector having a simple grounding structure.

In order to achieve the object set forth, an electrical connector in accordance with the present invention comprises a dielectric housing, a shell enclosing the dielectric housing, a pair of ground plates, and a number of terminals received in the dielectric housing. The dielectric housing comprises a base, a pair of brackets extending downwardly from opposite ends of the base. Each brackets has a shoulder defining a retention slit extending therethrough. The shell is assembled to the dielectric housing and has a pair of cantilever arms, each of which received in the retention slit and electrically connecting with the ground.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of an electrical connector in accordance with the present invention;

FIG. 2 is an assembled view of FIG. 1;

FIG. 3 is a view similar to FIG. 2 but taken from another aspect; and

FIG. 4 is a cross-sectional view of the electrical connector taken along line 4-4 of FIG. 2.

### DETAILED DESCRIPTION OF THE INVENTION

Reference will now be made in detail to the preferred embodiment of the present invention.

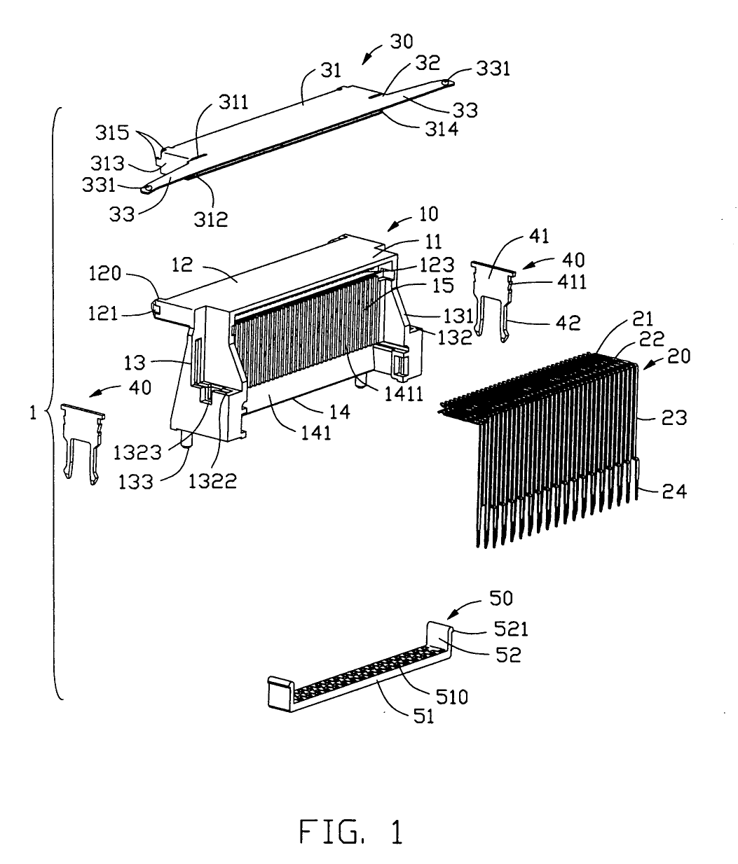

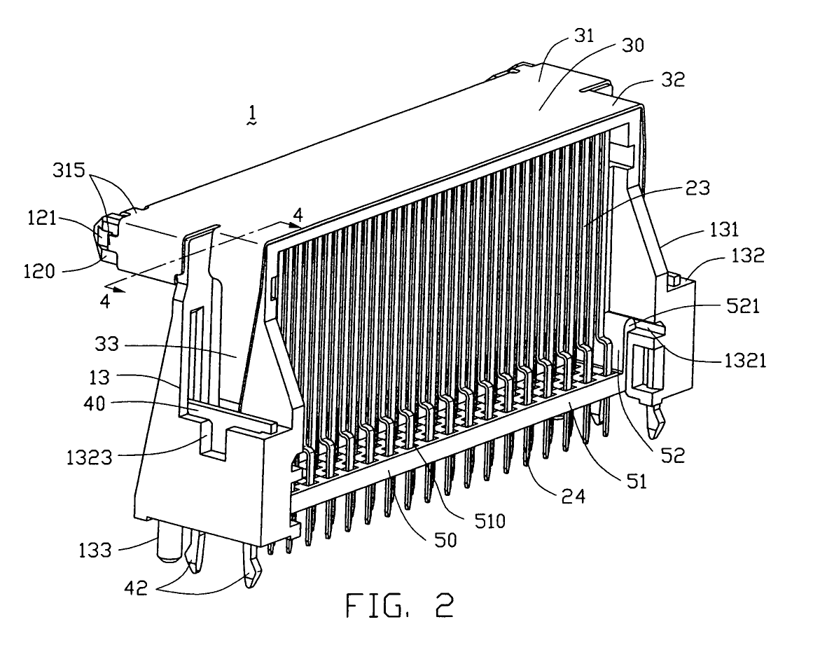

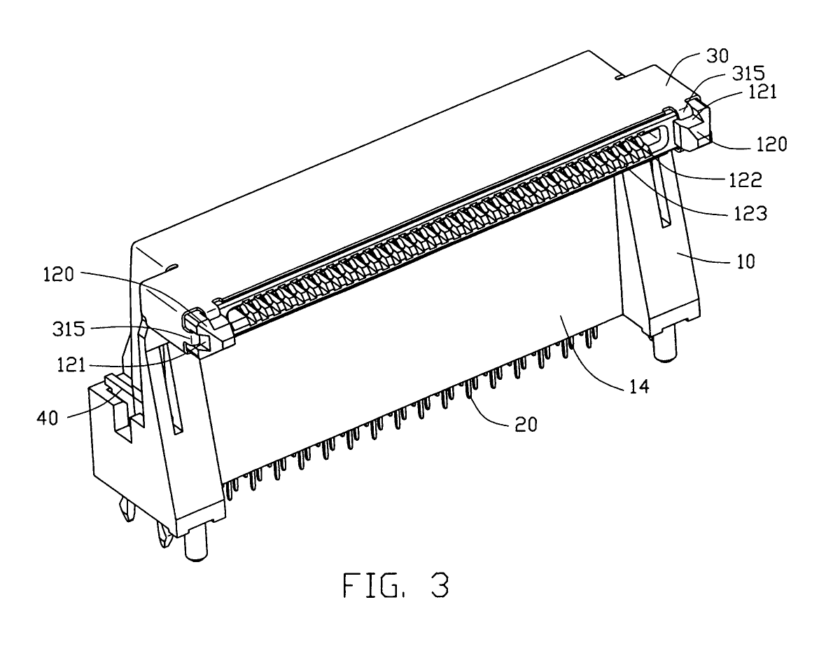

Referring to FIGS. 1 to 3, an electrical connector 1 in accordance with the present invention comprises a dielectric housing 10, a number of terminals 20 received in the dielectric housing 10, a shell 30 attached the dielectric housing 10, a pair of ground plates 40, and a spacer 50.

The dielectric housing 10 comprises a base 11, a rectangular mating section 12 extending forwardly from the base 11 for mating with a complementary connector (not shown), a pair of brackets 13 extending downwardly from opposite ends of the base 11, and a rear wall 14 extending between the brackets 13. A pair of guiding posts 120 extend forwardly from opposite ends of the mating section 12, each of which 120 has three recesses 121 respectively defined in a top side, a bottom side and a outer side thereof. An engaging space 122 is defined in a front end of the mating section 12. The mating section 12 defines a number of passages 123 extending rearwardly through the base 11. Each bracket 13 includes a rib 131 and a shoulder 132 extending outwardly from the rib 131. The rear wall 14 and the brackets 11 together define a receiving space 15. The rear wall 14 defines a number of slots 1411 extending therethrough. Each shoulder 132 comprises a pair of latching openings 1321 in an inner face thereof, a retention slit 1322 extending downwardly therethrough, and a rectangular opening 1323 adjacent to and communicating with the retention slit 1322. A pair of locating posts 133 extend from a bottom of the shoulders 132.

The shell 30 comprises a frame 31, an extending portion 32 extending rearwardly from the frame 31 and a pair of cantilever arms 33 extending transversely from opposite ends of the extending portion 32. The frame 31 includes an upper wall 311, a lower wall 312 opposite to the upper wall 311 and a pair of side walls 313, 314 connecting the upper and bottom walls 311, 312. The extending portion 32 extends rearwardly from the upper wall 311 of the frame 31. Each cantilever arm 33 has a protrusion 331 at a distal end thereof. A number of latching tabs 315 are formed in opposite sides of the frame 31.

Each terminal 20 comprises a mating portion 21, a retaining portion 22 extending rearwardly from the mating portion 21, a connecting portion 23 extending downwardly from the retaining portion 22 and a free tip 24 extending downwardly from the connecting portion 23.

The ground plates 40 are made of metal material, each of which comprises a flat body portion 41 and a pair of retention legs 42 extending downwardly from opposite sides of the body portion 41. A number of barbs 411 are formed at opposite sides of the body portion 41. The spacer 50 comprises a locating plate 51 having a plurality of locating holes 510 therein and a pair of latching arms 52 extending upwardly from opposite ends of the locating plate 51. Each latching arm 52 has a hook 521 at a top end thereof.

In assembly, the mating portion 21 of the terminal 20 projects into the engaging space 122 with the retention portion 22 being retained in corresponding passage 123 of the base 11 and the connecting portion 23 being received in corresponding slot 1411 of the rear wall 14. The free tip 24 of the terminal 20 extends through the locating hole 51. The hook 521 of the spacer 50 is latched in the latching opening 1321 for retaining the spacer 50 on the dielectric housing 10.

The shell 30 is assembled to the dielectric housing 10 along a front-to-back direction. The frame 31 encloses the mating section 12 of the dielectric housing 10 and the extending portion 32 encloses the base 11. The two cantilever arms 33 are bent downwardly and received in corresponding retention slits 1322 of the shoulder 132.

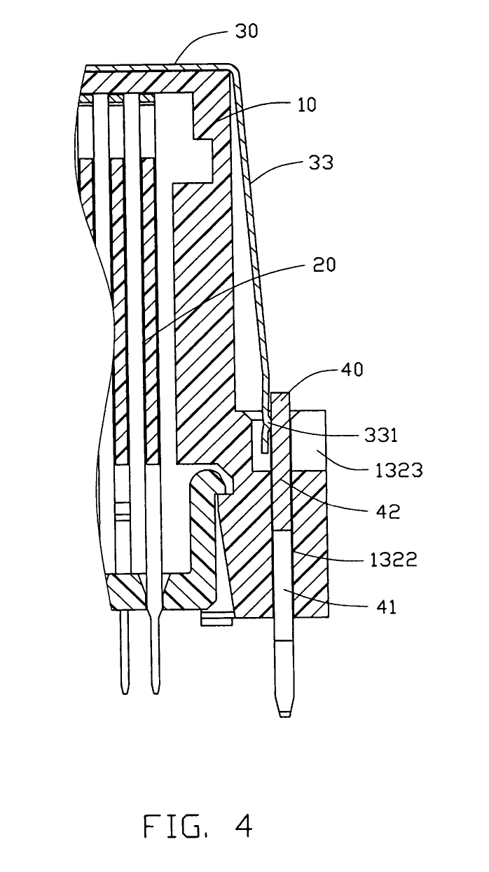

Referring to FIG. 1 in conjunction with FIG. 4, the ground plate 40 inserts into the retention slit 1322 with the barbs 411 of the body portion 41 interferentially engaging with an inner wall of the retention groove 1322. The protrusions 331 of the cantilever arms 33 resiliently abut against the body portion 41 for electrical connecting with the ground plates 40. The retention legs 42 extend out of the dielectric housing 10 and connect with a ground trace of the PCB for establishing a grounding path from the shell 30 to the PCB. Thus, the shell 30 and the ground plates 40 together form a simple grounding device, which can be manufactured and assembled efficiently.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector, comprising:
a dielectric housing comprises a base, a pair of brackets extending downwardly from opposite ends of the base, each bracket having a shoulder with a retention slit extending therethrough;
a pair of ground plates received in the retention slits of the brackets;
a shell assembled to the dielectric housing and having a pair of cantilever arms received in the retention slits and electrically connecting with corresponding ground plates; and
a plurality of terminals received in the dielectric housing.

2. The electrical connector as claimed in claim 1, wherein the shoulder defines an opening adjacent to and communicating with the retention slit, and the cantilever arm is inserted in the retention slit via the opening.

3. The electrical connector as claimed in claim 2, wherein the cantilever arm has a protrusion at a distal end thereof abutting against corresponding ground plate.

4. The electrical connector as claimed in claim 1, wherein the dielectric housing comprises a mating section extending forwardly from the base, and a rear wall extending between the brackets.

5. The electrical connector as claimed in claim 4, wherein the mating section defines a number of passages extending rearwardly through the base.

6. The electrical connector as claimed in claim 5, wherein each terminal comprises a mating portion, a retaining portion extending rearwardly from the mating portion, a connecting portion extending downwardly from the retaining portion, and a free tip extending downwardly from the connecting portion, and wherein the retaining portion is retained in said passage.

7. The electrical connector as claimed in claim 1, wherein the shell comprises a frame and an extending portion extending from the frame, and wherein said cantilever arm extends downwardly from opposite ends of the extending portion.

8. The electrical connector as claimed in claim 7, wherein the frame has a plurality of latching tabs formed in opposite ends thereof.

9. The electrical connector as claimed in claim 8, wherein the mating section of the dielectric housing has a pair of guiding posts extending from opposite ends thereof, and the guiding post defines a number of recesses for engagement with said latching tabs.

10. The electrical connector as claimed in claim 1, wherein the electrical connector further comprises a spacer attached to the dielectric housing.

11. The electrical connector as claimed in claim 10, wherein the spacer provides a plurality of locating holes for locating the terminals therein.

12. The electrical connector as claimed in claim 1, wherein each ground plate comprises a body portion, and a pair of retention legs extending downwardly from the body portion.

13. The electrical connector as claimed in claim 12, wherein the body portion has a plurality of barbs interferentially engaging with an inner wall of the retention slit.

14. An electrical connector, comprising:
a dielectric housing comprises a base, a pair of brackets extending downwardly from opposite ends of the base;
a pair of ground plates received in the brackets, respectively;
a plurality of terminals received in the dielectric housing; and
a shell assembled to the dielectric housing and having a pair of spring arms; wherein
a bottom end of the ground plate extends beyond a bottom face of the housing for mounting to a printed circuit board, and a top end of the ground plate mechanically and electrically engaged with the corresponding spring arm.

15. The electrical connector as claimed in claim 14, wherein said spring arm downwardly extends from the shell with thereof a distal bottom end engaged with the corresponding ground plate.
